(19) United States
(12) Patent Application Publication
(10) Pub. No.: US 2018/0335553 A1
(43) Pub. Date: Nov. 22, 2018

(54) METHOD FOR MANUFACTURING COLOR FILTER SUBSTRATE AND METHOD FOR MANUFACTURING LIQUID CRYSTAL PANEL

(71) Applicant: HKC Corporation Limited, Shenzhen City, Guangdong (CN)

(72) Inventor: Chung-Kuang CHIEN, Chongqing (CN)

(73) Assignee: HKC Corporation Limited, Shenzhen City , Guangdong (CN)

(21) Appl. No.: 15/540,998

(22) PCT Filed: Mar. 24, 2017
(86) PCT No.: PCT/CN2017/078123

§ 371 Date: Jun. 29, 2017

(30) Foreign Application Priority Data
Dec. 29, 2016 (CN) 201611249667.0

(51) Int. Cl. G02B 5/22

(52) U.S. Cl. CPC G02B 5/22

(57) ABSTRACT

This application relates to a method for manufacturing a color filter substrate and a method for manufacturing a liquid crystal panel applying the same. The method for manufacturing a color filter substrate includes: providing a first substrate; sequentially forming a plurality of color filter layers arranged in parallel on the first substrate, so as to form color filters; while forming one of the color filter layers, forming a plurality of photo spacers and at least one of the color filter layers by using a single mask, where the photo spacers are formed on the color filter, and a material of one of the color filter layers is the same as a material of the photo spacers; and forming a transparent common electrode layer, disposed on the color filter and the photo spacers.

### BACKGROUND

### Technical Field

This application relates to a manufacturing manner, and in particular, to a method for manufacturing a color filter substrate and a method for manufacturing a liquid crystal panel applying the same.

### Related Art

With the development of science and technology, liquid crystal displays have a plurality of advantages such as power saving, no radiation, small volume, low power consumption, flat panel, high resolution, and stable image quality. Particularly, with the increasing popularity of current various information products such as mobile phones, notebook computers, digital cameras, personal digital assistants (PDAs), and liquid crystal screens, the demand for liquid crystal displays (LCDs) increases significantly. Therefore, how to improve the efficiency of the production process and simplify the process steps is a problem manufacturers need to face.

Manufacturing of a four-color color filter (CF) of a conventional liquid crystal panel requires an additional lithography process compared with manufacturing of a three-color color filter. For any general standard process such as a color filter or color filter on array (COA) process, the formation of photo spacers (PSs) needs to be performed after the formation of red/green/blue color photoresists. The function of the photo spacers is to support the liquid crystal cell thickness. As a result, more materials need to be used, making it difficult to manage and control; and the manufacture process is complex, requiring high equipment investment.

### SUMMARY

To resolve the foregoing technical problem, an objective of this application is to provide a method for manufacturing a color filter substrate and a method for manufacturing a liquid crystal panel applying the same, which not only can reduce the problems during manufacturing and production, but also can shorten the production time and reduce the equipment investment.

The objective of this application is achieved and the technical problem of this application is resolved by using the following technical solution. According to this application, a method for manufacturing a color filter substrate is provided, including: providing a first substrate; sequentially forming a plurality of color filter layers arranged in parallel on the first substrate, so as to form color filters; while forming one of the color filter layers, forming a plurality of photo spacers and at least one of the color filter layers by using a single mask, where the photo spacers are formed on the color filters, and a material of the at least one of the color filter layers is the same as a material of the photo spacers; and forming a transparent common electrode layer, disposed on the color filters and the photo spacers.

A method for manufacturing a liquid crystal panel includes: providing a first substrate; sequentially forming a plurality of color filter layers arranged in parallel on the first substrate, so as to form color filters; while forming one of the color filter layers, forming a plurality of photo spacers and at least one of the color filter layers by using a single mask, where the photo spacers are formed on the color filters, and a material of the at least one of the color filter layers is the same as a material of the photo spacers; and forming a transparent common electrode layer, disposed on the color filters and the photo spacers, to form a color filter substrate; providing a thin film transistor substrate, disposed opposite to the color filter substrate, where the photo spacers are located between the color filter substrate and the thin film transistor substrate, so as to define a liquid crystal space; and forming a liquid crystal layer between the color filter substrate and the thin film transistor substrate, and filling up the liquid crystal space. In addition, because both a white photoresist and a photo spacer may use transparent photoresist characteristics, design of a mask is changed during exposure of a process of the white photoresist, and exposure is performed for a position of the white photoresist and a position of the photo spacer, so that one lithography process may be performed to complete manufacturing of the white photoresist and the photo spacer.

The technical problem of this application may also be further resolved by using the following technical measure.

In an embodiment of this application, in the manufacturing method, one of the color filter layers and the photo spacers are both formed by means of a same photoresist coating, exposure, development, and masking process.

In an embodiment of this application, in the manufacturing method, the mask is a gray-scale mask or a half-tone mask.

In an embodiment of this application, in the manufacturing method, the color filter layer may be a white color filter layer, and a material of the white color filter layer is the same as a material of the photo spacers.

In an embodiment of this application, a movable structure is designed at a corresponding position of an opposite vertex of the photo spacer.

This application can reduce the problems during manufacturing and production, requires only one single material, and can shorten the production time and reduce the equipment investment.

### BRIEF DESCRIPTION OF THE DRAWINGS

FIG. 1a is an exemplary schematic sectional view of a liquid crystal display panel;

FIG. 1b is an exemplary schematic sectional view of manufacturing of a liquid crystal display panel;

FIG. 1c is an exemplary schematic diagram of a manufacturing process of a conventional color filter;

FIG. 1d is an exemplary schematic diagram of another manufacturing process of a conventional color filter;

FIG. 2 is a schematic diagram showing a manufacturing process of a color filter applied to a liquid crystal display panel according to the method of this application;

FIG. 3a is a schematic diagram of coating of a white photoresist in a manufacturing process of a color filter in a conventional liquid crystal display panel;

FIG. 3b is a schematic diagram of exposure of a white photoresist in a manufacturing process of a color filter in a conventional liquid crystal display panel;

FIG. 3c is a schematic diagram of development of a white photoresist in a manufacturing process of a color filter in a conventional liquid crystal display panel;

FIG. 4a is a schematic diagram showing coating of a white photoresist and a photo spacer in a manufacturing process of a color filter applied to a liquid crystal display panel according to the method of this application;

FIG. 4b is a schematic diagram showing exposure of a white photoresist and a photo spacer in a manufacturing process of a color filter applied to a liquid crystal display panel according to the method of this application; and

FIG. 4c is a schematic diagram showing development of a white photoresist and a photo spacer in a manufacturing process of a color filter applied to a liquid crystal display panel according to the method of this application.

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “in”, “out”, and “side surface” merely refer to directions of the accompanying drawings. Therefore, the used terms about directions are used to describe and understand this application, and are not intended to limit this application.

The accompanying drawings and the description are considered to be essentially exemplary, rather than limitative. In figures, units with similar structures are represented by using a same reference number. In addition, for understanding and ease of description, a size and a thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a substrate is described to be “on” “another component”, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that a component is located on or below a target component, but does not mean that the component needs to be located on top of a gravity direction.

To further describe the technical means used in this application to achieve the preset invention objective and effects thereof, specific implementations, structures, features, and effects of a method for manufacturing a color filter substrate and a method for manufacturing a liquid crystal panel applying the same that are provided according to this application are described in detail below with reference to the drawings and preferred embodiments.

A liquid crystal panel of this application may include a thin film transistor (TFT) substrate, a color filter (CF) substrate, and a liquid crystal layer formed between the two substrates.

In an embodiment, the liquid crystal panel of this application may be a curved display panel.

In an embodiment, the thin film transistor (TFT) and the color filter (CF) of this application may be formed on a same substrate.

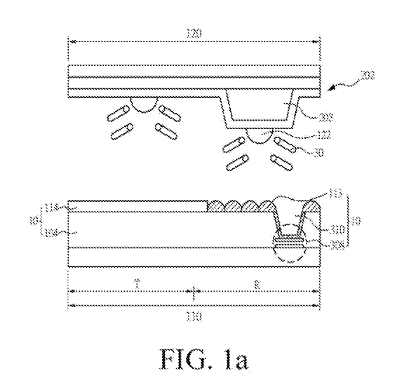

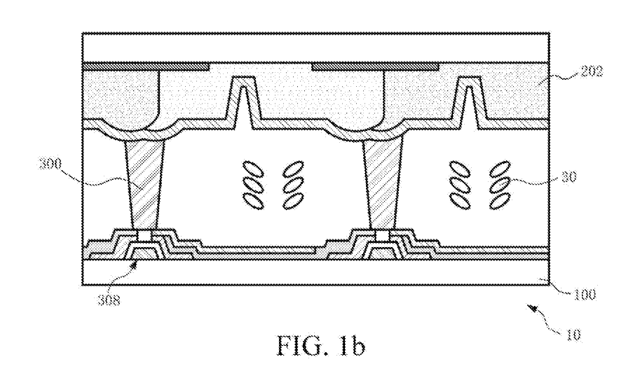

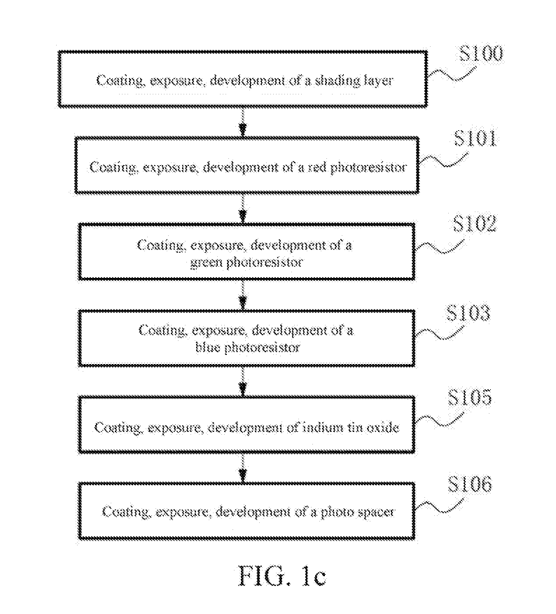

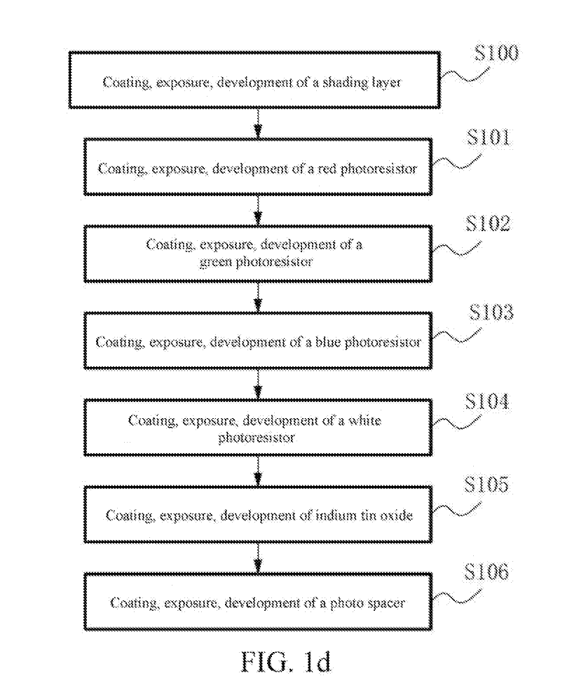

FIG. 1a is an exemplary schematic sectional view of a liquid crystal display panel and FIG. 1b is an exemplary schematic sectional view of manufacturing of a liquid crystal display panel. Referring to FIG. 1a and FIG. 1b, on the current technological development of a liquid crystal display, a dual gap transflective MVA liquid crystal display is used as an example. Generally, for the dual gap transflective liquid crystal display, an adjustment layer 208 is disposed in a reflection region R. As shown in FIG. 1a, the adjustment layer may be disposed on a color filter substrate side or a thin film transistor substrate side. As shown in FIG. 1a, a basic structure of the dual gap transflective MVA liquid crystal display includes a first substrate 10, a color filter substrate 202, and a liquid crystal layer 30. The first substrate 10 includes a plurality of sub-pixel regions 110, and each sub-pixel region 110 includes a reflection region R and a transmission region T. The color filter substrate 202 also includes a plurality of sub-pixel regions 120, the sub-pixel regions 120 are respectively corresponding to the a plurality of sub-pixel regions 110 of the first substrate, and each sub-pixel region 120 includes an adjustment layer 208 at a position corresponding to the reflection region R. The liquid crystal layer 30 is disposed between the first substrate 10 and the color filter substrate 202.

Still referring to FIG. 1a and FIG. 1b, each sub-pixel region 110 of the first substrate 10 internally includes a thin film transistor, and a storage capacitor 308 disposed below the reflection region R and above the first substrate 100. Next, a flat layer 104 is formed on an upper surface of the first substrate 10. Then, an uneven surface on the reflection region R is made on the flat layer 104, and then is plated with a metal with a high reflectivity (such as aluminum or silver) to serve as a reflective electrode 113, and the transmission region T of each sub-pixel region 110 also includes a transparent electrode 114. It should be noted that, the reflection region R of each sub-pixel region 110 of the first substrate 10 further includes a contact hole 310, used to electrically connect the reflective electrode 113 and the storage capacitor 308. In addition, the color filter substrate 202 further includes alignment protrusions 122 (PR) at the positions corresponding to the reflection region R and the transmission region T of the first substrate 10. Because the alignment protrusion 122 changes distribution of power lines, liquid crystal molecules lean toward the direction of the alignment protrusion 122 to generate a multi-domain liquid crystal alignment (Multi-domains) effect, to achieve a wide viewing angle technology, and improve a gray-scale inversion problem existing during single-domain liquid crystal alignment (Single-domain). As shown in FIG. 1b, generally, when the first substrate 10 and the color filter substrate 202 are assembled, the color filter substrate 202 further includes a photo spacer 300 (PS) to fix a cell gap between panels. A plurality of platforms corresponding to the photo spacer 300 are designed on the first substrate 10, so that the photo spacer 300 can more stably maintain the cell gap between panels. In the foregoing description, an example of a reflective wide viewing angle liquid crystal display panel is used, but the application scope of this application is not limited thereto. This application may be further applied to a dual gap transflective liquid crystal display panel and a single gap transflective liquid crystal display panel.

FIG. 1c is an exemplary schematic diagram of a manufacturing process of a conventional color filter. Referring to FIG. 1c, the manufacturing process of a color filter includes: S100 of coating, exposure, development manufacturing of a shading layer of a substrate; S101 of coating, exposure, development manufacturing of a red photoresist of the substrate; S102 of coating, exposure, development manufacturing of a green photoresist of the substrate; S103 of coating, exposure, development manufacturing of a blue photoresist of the substrate; S105 of coating, exposure, development manufacturing of indium tin oxide of the substrate; and S106 of coating, exposure, development manufacturing of a photo spacer of the substrate.

FIG. 1d is an exemplary schematic diagram of another manufacturing process of a conventional color filter. Referring to FIG. 1c and FIG. 1d, the manufacturing process of a color filter substrate includes: S100 of coating, exposure, development manufacturing of a shading layer of a substrate; S101 of coating, exposure, development manufacturing of a red photoresist of the substrate; S102 of coating, exposure, development manufacturing of a green photoresist of the substrate; S103 of coating, exposure, development manufacturing of a blue photoresist of the substrate; S104 of coating, exposure, development manufacturing of a white photoresist of the substrate; S105 of coating, exposure, development manufacturing of indium tin oxide of the substrate; and S106 of coating, exposure, development manufacturing of a photo spacer of the substrate. A difference is that manufacturing of a four-color color filter of a conventional liquid crystal panel requires an additional lithography process (such as S104 of coating, exposure, development manufacturing of a white photoresist of the substrate) compared with manufacturing of a three-color color filter.

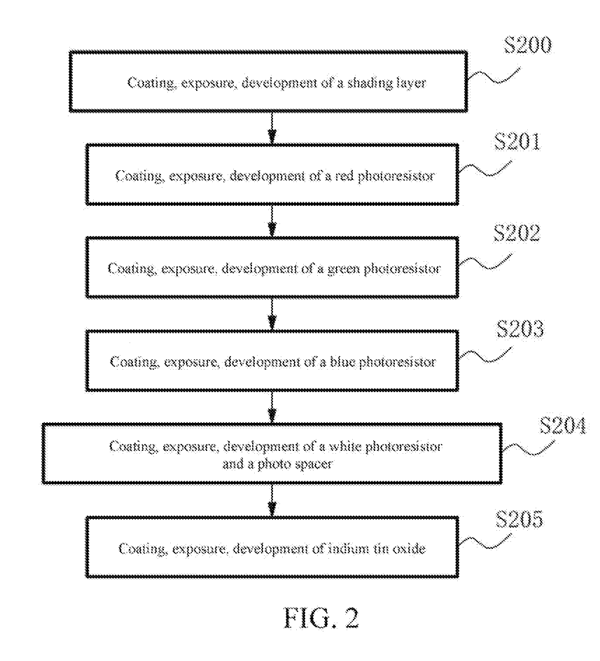

FIG. 2 is a schematic diagram showing a manufacturing process of a color filter applied to a liquid crystal display panel according to the method of this application. Referring to FIG. 1d and FIG. 2, in an embodiment of this application, the manufacturing process of a color filter substrate includes: S200 of coating, exposure, development manufacturing of a shading layer of a substrate; S201 of coating, exposure, development manufacturing of a red photoresist of the substrate; S202 of coating, exposure, development manufacturing of a green photoresist of the substrate; S203 of coating, exposure, development manufacturing of a blue photoresist of the substrate; S204 of coating, exposure, development manufacturing of a white photoresist and a photo spacer of the substrate; and S205 of coating, exposure, development manufacturing of indium tin oxide of the substrate. A difference is that in a manufacturing process of a four-color color filter of a conventional liquid crystal panel, because both a white photoresist and a photo spacer may use transparent photoresist characteristics, design of a mask is changed during exposure of a process of the white photoresist, and exposure is performed for a position of the white photoresist and a position of the photo spacer, so that one lithography process (such as S204 of coating, exposure, development manufacturing of a white photoresist and a photo spacer of the substrate) may be performed to complete manufacturing of the white photoresist and the photo spacer.

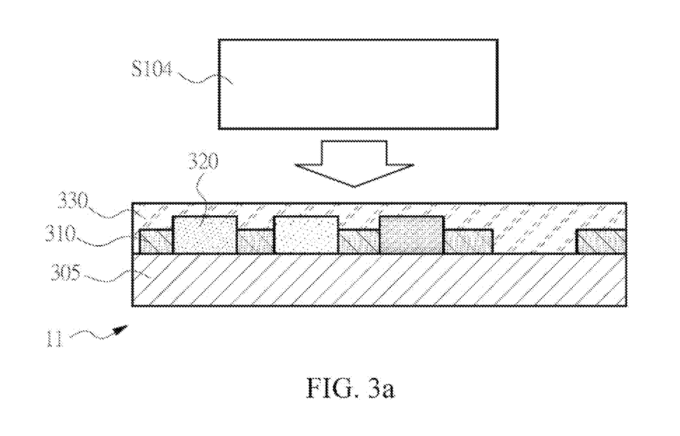

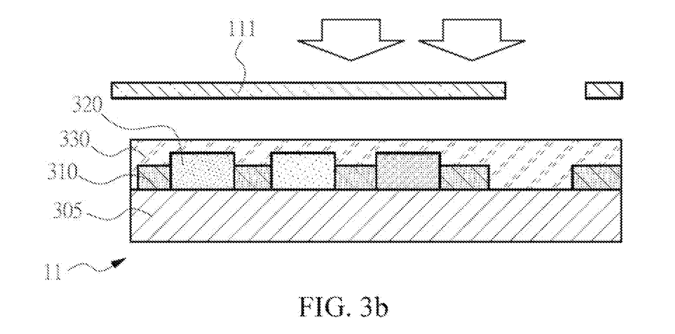

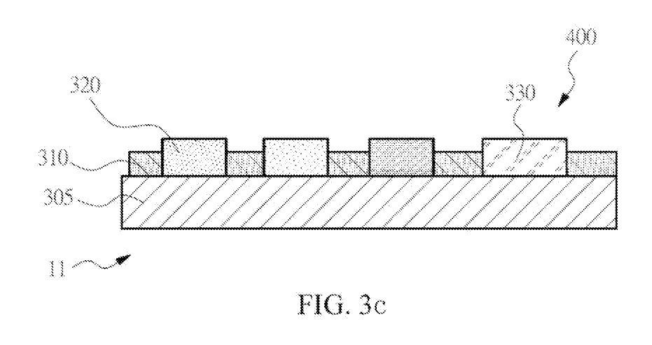

FIG. 3a is a schematic diagram of coating of a white photoresist in a manufacturing process of a color filter in a conventional liquid crystal display panel, FIG. 3b is a schematic diagram of exposure of a white photoresist in a manufacturing process of a color filter in a conventional liquid crystal display panel; and FIG. 3c is a schematic diagram of development of a white photoresist in a manufacturing process of a color filter in a conventional liquid crystal display panel. Referring to FIG. 3a, FIG. 3b, and FIG. 3c, in an embodiment, in a conventional liquid crystal display panel 400, in S104 of coating, exposure, development manufacturing of a white photoresist 330 of a substrate 11, a color filter substrate 11 includes: a first substrate 305; a shading layer 310 formed on the first substrate 305; a red/green/blue color filter layer 330 formed on the first substrate 305; and a mask 111 used to perform exposure manufacturing on a white color filter layer 330.

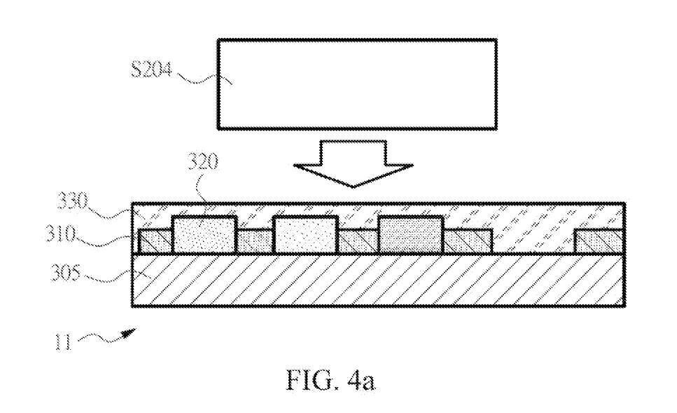

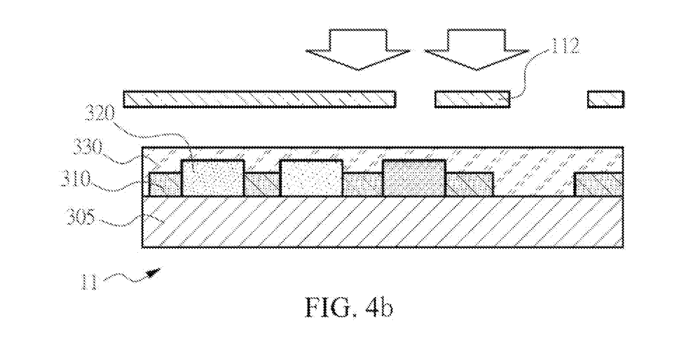

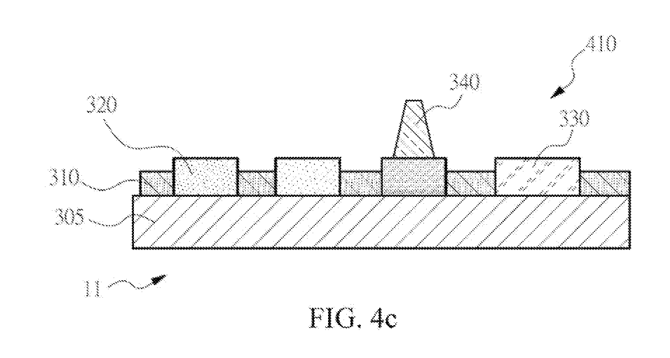

FIG. 4a is a schematic diagram showing coating of a white photoresist and a photo spacer in a manufacturing process of a color filter applied to a liquid crystal display panel according to the method of this application; FIG. 4b is a schematic diagram showing exposure of a white photoresist and a photo spacer in a manufacturing process of a color filter applied to a liquid crystal display panel according to the method of this application; and FIG. 4c is a schematic diagram showing development of a white photoresist and a photo spacer in a manufacturing process of a color filter applied to a liquid crystal display panel according to the method of this application. Referring to FIG. 4a, FIG. 4b, and FIG. 4c, in an embodiment of this application, in S204 of coating, exposure, development manufacturing of a white photoresist 330 and a photo spacer 340 of a substrate 11, a color filter substrate 11 includes: a first substrate 305; a color filter 320, disposed on the first substrate 305 and including a plurality of color filter layers arranged in parallel 330; a plurality of photo spacers 340, disposed on the color filters 320, where a material of the at least one of the color filter layers 330 is the same as a material of the photo spacers 340; a shading layer 310 formed on the first substrate 305; and a transparent common electrode layer (not shown in the figure), disposed on the color filters 320 and the photo spacers 340. The color filter layer may be a white color filter layer 330, and a material of the white color filter layer 330 is the same as a material of the photo spacers 340. The mask 112 is designed as a multi-gray-scale mask, and the multi-gray-scale mask is a gray-scale mask or a half-tone mask.

The multi-gray-scale mask may be classified into a gray-tone mask and a half-tone mask. The gray-tone mask is that a micro gap under resolution of an exposure machine is made, and then a position of the micro gap shades a part of light source, to achieve a half exposure effect. On the other hand, the half-tone mask is that a semipermeable film is used to perform half exposure. In both of the foregoing two manners, three exposure levels: an exposed part, a half exposed part, and an unexposed part may be presented after one exposure process. Therefore, after development is performed, a photoresist with two thicknesses can be formed (by means of such a thickness difference of the photoresist, patterns can be written to a panel substrate under less pieces than usual, and panel production efficiency can be improved).

Referring to FIG. 4a, FIG. 4b, and FIG. 4c, in an embodiment of this application, a method for manufacturing a color filter substrate 11 includes: providing a first substrate 305; sequentially forming a plurality of color filter layers arranged in parallel 320 on the first substrate 305, to form color filter 320; while forming one of the color filter layers 330, forming a plurality of photo spacers 340 and at least one of the color filter layers 330 by using a single mask, where the photo spacers are formed on the color filters 320, and a material of the at least one of the color filter layers 330 is the same as a material of the photo spacers 340; and forming a transparent common electrode layer (not shown in the figure), disposed on the color filters 320 and the photo spacers 340. In addition, because both a white photoresist 330 and a photo spacer 340 may use transparent photoresist characteristics, design of a mask 112 is changed during exposure of a process of the white photoresist 330, and exposure is performed for a position of the white photoresist 330 and a position of the photo spacer 340, so that one lithography process may be performed to complete manufacturing of the white photoresist 330 and the photo spacer 340.

Referring to FIG. 4a, FIG. 4b, and FIG. 4c, in an embodiment of this application, in coating, exposure, development manufacturing of the white photoresist 330 and the photo spacer 340 of the substrate 11, completion by using a mask 112 causes an indium tin oxide thin film (not shown in the figure) on the photo spacer 340. To resolve the problem, the method may be: After gap pairing, a movable structure is designed at a corresponding position of an opposite vertex of the photo spacer 340, so as to avoid a short circuit problem of an indium tin oxide thin film (not shown in the figure) of the photo spacer 340 and an array side electrode of the substrate 11.

Referring to FIG. 4a, FIG. 4b, and FIG. 4c, in an embodiment of this application, a liquid crystal panel 410 includes: a color filter substrate 11, including: a first substrate 305; color filter 320, disposed on the first substrate 305 and including a plurality of color filter layers arranged in parallel 320; a plurality of photo spacers 340, disposed on the color filters 320, where a material of the at least one of the color filter layers 330 is the same as a material of the photo spacers 340; and a transparent common electrode layer (not shown in the figure), disposed on the color filters 320 and the photo spacers 340; a thin film transistor substrate (not shown in the figure), disposed opposite to the color filter substrate 11, where the photo spacers 340 are located between the color filter substrate 11 and the thin film transistor substrate (not shown in the figure), so as to define a liquid crystal space; and a liquid crystal layer located between the color filter substrate 11 and the thin film transistor substrate (not shown in the figure), and filling up the liquid crystal space. The color filter layer may be a white color filter layer 330, and a material of the white color filter layer 330 is the same as a material of the photo spacers 340. The mask 112 is designed as a multi-gray-scale mask, and the multi-gray-scale mask is a gray-scale mask or a half-tone mask.

Referring to FIG. 4a, FIG. 4b, and FIG. 4c, in an embodiment of this application, a method for manufacturing a liquid crystal panel 410 includes: providing a first substrate 305; sequentially forming a plurality of color filter layers arranged in parallel 320 on the first substrate 305, to form color filter 320; while forming one of the color filter layers 330, forming a plurality of photo spacers 340 and at least one of the color filter layers 330 by using a single mask, where the photo spacers are formed on the color filters 320, and a material of the at least one of the color filter layers 330 is the same as a material of the photo spacers 340; forming a transparent common electrode layer (not shown in the figure), disposed on the color filters 320 and the photo spacers 340, to form a color filter substrate 11; providing a thin film transistor substrate (not shown in the figure), disposed opposite to the color filter substrate 11, where the photo spacers 340 are located between the color filter substrate 11 and the thin film transistor substrate (not shown in the figure), so as to define a liquid crystal space; and forming a liquid crystal layer between the color filter substrate 11 and the thin film transistor substrate (not shown in the figure), and filling up the liquid crystal space. In addition, because both a white photoresist 330 and a photo spacer 340 may use transparent photoresist characteristics, design of a mask is changed during exposure of a process of the white photoresist 330, and exposure is performed for a position of the white photoresist 330 and a position of the photo spacer 340, so that one lithography process may be performed to complete manufacturing of the white photoresist 330 and the photo spacer 340.

Referring to FIG. 4a, FIG. 4b, and FIG. 4c, in an embodiment of this application, one of the color filter layers 330 and the photo spacers 340 are both formed by means of a same photoresist coating, exposure, development, and masking process.

This application can reduce the problems during manufacturing and production, requires only one single material, and can shorten the production time and reduce the equipment investment.

Terms such as “in some embodiments” and “in various embodiments” are repeatedly used. Usually, the terms do not refer to a same embodiment; but they may also refer to a same embodiment. Words such as “comprise”, “have”, “include” are synonyms, unless other meanings are indicated in the context.

The foregoing descriptions are merely preferred embodiments of this application, and are not intended to limit this application in any form. Although this application has been disclosed above through the preferred embodiments, the embodiments are not intended to limit this application. Any person skilled in the art can make some equivalent variations or modifications according to the foregoing disclosed technical content without departing from the scope of the technical solutions of this application to obtain equivalent embodiments. Any simple amendment, equivalent change or modification made to the foregoing embodiments according to the technical essence of this application without departing from the content of the technical solutions of this application shall fall within the scope of the technical solutions of this application.

What is claimed is:

1. A method for manufacturing a color filter substrate, comprising:
providing a first substrate;
sequentially forming a plurality of color filter layers arranged in parallel on the first substrate, so as to form color filters;
when forming one of the color filter layers, forming a plurality of photo spacers and at least one of the color filter layers by using a single mask, wherein the photo spacers are formed on the color filters, and a material of the at least one of the color filter layers is the same as a material of the photo spacers; and
forming a transparent common electrode layer, disposed on the color filter and the photo spacers.

2. The method for manufacturing a color filter substrate according to claim 1, wherein the color filter layers comprise a white color filter layer.

3. The method for manufacturing a color filter substrate according to claim 2, wherein a material of the white color filter layer is the same as a material of the photo spacers.

4. The method for manufacturing a color filter substrate according to claim 2, wherein the color filter layers are sequentially formed on the first substrate, and the white color filter layer and the photo spacer are formed by using the same mask.

5. The method for manufacturing a color filter substrate according to claim 1, wherein one of the color filter layers and the photo spacers are both formed by means of a same photoresist coating, exposure, development, and masking process.

6. The method for manufacturing a color filter substrate according to claim 1, wherein the mask is a gray-scale mask.

7. The method for manufacturing a color filter substrate according to claim 1, wherein the mask is a half-tone mask.

8. A method for manufacturing a liquid crystal panel, comprising:
providing a first substrate;
sequentially forming a plurality of color filter layers arranged in parallel on the first substrate, so as to form color filters;
when forming one of the color filter layers, forming a plurality of photo spacers and at least one of the color filter layers by using a single mask, wherein the photo spacers are formed on the color filter, and a material of the at least one of the color filter layers is the same as a material of the photo spacers; and
forming a transparent common electrode layer, disposed on the color filter and the photo spacers, to form a color filter substrate;
providing a thin film transistor substrate, disposed opposite to the color filter substrate, wherein the photo spacers are located between the color filter substrate and the thin film transistor substrate, so as to define a liquid crystal space; and
forming a liquid crystal layer between the color filter substrate and the thin film transistor substrate, and filling up the liquid crystal space.

9. The method for manufacturing a liquid crystal panel according to claim 8, wherein the color filter layers comprise a white color filter layer.

10. The method for manufacturing a liquid crystal panel according to claim 9, wherein a material of the white color filter layer is the same as a material of the photo spacers.

11. The method for manufacturing a liquid crystal panel according to claim 9, wherein the color filter layers are sequentially formed on the first substrate, and the white color filter layer and the photo spacer are formed by using the same mask.

12. The method for manufacturing a liquid crystal panel according to claim 8, wherein one of the color filter layers and the photo spacers are both formed by means of a same photoresist coating, exposure, development, and masking process.

13. The method for manufacturing a liquid crystal panel according to claim 8, wherein the mask is a gray-scale mask.

14. The method for manufacturing a liquid crystal panel according to claim 8, wherein the mask is a half-tone mask.

15. A method for manufacturing a color filter substrate, comprising:
providing a first substrate;
sequentially forming a plurality of color filter layers arranged in parallel on the first substrate, so as to form color filters;
while forming one of the color filter layers, forming a plurality of photo spacers and at least one of the color filter layers by using a single mask, wherein the photo spacers are formed on the color filter, and a material of one of the color filter layers is the same as a material of the photo spacers; and
forming a transparent common electrode layer, disposed on the color filter and the photo spacers, wherein
the color filter layer is a white color filter layer, wherein a material of the white color filter layer is the same as a material of the photo spacers;
one of the color filter layers and the photo spacers are both formed by means of a same photoresist coating, exposure, development, and masking process; and
the mask is a half-tone mask, wherein
a movable structure is located at a corresponding position of an opposite vertex of the photo spacer.
